(19) United States
(12) Patent Application Publication
(10) Pub. No.: US 2024/0385954 A1
(43) Pub. Date: Nov. 21, 2024

(54) AUTOMATED GENERATION OF USER INTERFACE AND USER EXPERIENCE TEST CASE SUMMARIES

(71) Applicant: INTERNATIONAL BUSINESS MACHINES CORPORATION, Armonk, NY (US)

(72) Inventors: Yu Liu, Austin, TX (US); Anup Kalia, White Plains, NY (US); Saurabh Sinha, Danbury, CT (US); Rachel Tzoref-Brill, Haifa (IL); Jin Xiao, White Plains, NY (US)

(21) Appl. No.: 18/317,837

(22) Filed: May 15, 2023

(51) Int. Cl. G06F 11/36

(52) U.S. Cl. CPC G06F 11/3692; G06F 11/3664

(57) ABSTRACT

Generating a test case summary of an end-to-end test of a computer application includes identifying an edge for each test execution. Each execution corresponds to a transition of the user interface of the application from a source state to a target state. One or more attributes of each edge are determined. Natural language processing is performed on each edge. Based on the natural language processing, a label for each edge is derived from the one or more attributes of each edge. A test case summary of the end-to-end test is output. The test case summary combines the labels corresponding to each edge.

### STATEMENT REGARDING PRIOR DISCLOSURES BY THE INVENTOR OR A JOINT INVENTOR

The following disclosure(s) are submitted under 35 U.S.C. 102 (b)(1)(A):

DISCLOSURE(S): Liu et al., CrawLabel: computing natural-language labels for UI test cases, In Proceedings of the 3rd ACM/IEEE International Conference on Automation of Software Test, May 17, 2022, pp. 103-114.

### BACKGROUND

This disclosure relates to user interfaces and user experiences associated with interactive computer programs, and more particularly, to generating summaries of user interface test cases.

An essential component of virtually every interactive computer program is the program's user interface (UI). The UI is the component that enables a user to interact with a computer program, such as a web or other interactive computer application. The UI also contributes to the overall experience (UX) of the user in interacting with the computer program. UI/UX test cases play a significant role in the functional testing of interactive computer programs. A typical test case is a so-called unit test, which targets a computer program's method or functions by implementing instructions that a user would initiate in performing a particular action. End-to-end UI/UX test cases, by contrast, typically comprise a set of instructions that the user likely would initiate in navigating through the interactive computer program.

### SUMMARY

In one or more embodiments, a method includes identifying, by a processor, an edge for each test execution of an end-to-end test of an application under test (AUT) user interface (UI). Each edge corresponds to a transition of the UI from a source state to a target state of the UI. The method includes determining, by the processor, one or more attributes of each edge. The method includes generating, by a natural language processing (NLP) engine, a label for each edge. Each label is derived from the one or more attributes of each edge. The method includes outputting a test case summary of the end-to-end test. The test case summary combines labels corresponding to each edge.

The foregoing and other implementations can each optionally include one or more of the following features, alone or in combination. Some example embodiments include all the following features in combination.

In one aspect, determining one or more attributes of each edge includes determining contextual information based on attributes of the source state corresponding to each edge.

In another aspect, determining one or more attributes of each edge includes determining additional contextual information based on attributes of the target state corresponding to each edge.

In another aspect, the NLP engine is trained using supervised learning. The method includes selecting the NLP engine in response to determining the AUT is created using a framework used to create other AUTs including a training set for training the NLP engine.

In another aspect, the NLP engine implements a probabilistic context-free grammar to generate the one or more labels for each edge.

In another aspect, edges corresponding to application-specific program logic transitions are distinguished from edges corresponding to UI navigation. Labels are generated only for the edges corresponding to application-specific program logic transitions.

In another aspect, a learning module is provided for refining the labels and/or generating additional labels for one or more edges based on user feedback.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing a test case summary generator (TCSG) framework.

FIG. 2 illustrates an example architecture of executable TCSG framework of FIG. 1.

FIG. 3 illustrates an example method of operation of the TCSG framework of FIGS. 1 and 2.

FIG. 4 illustrates an example UI path of a test case summarized by TCSG framework of FIGS. 1 and 2.

FIG. 5 illustrates an example hierarchical tree structure of a UI state of an application.

FIGS. 6A and 6B illustrate, respectively, a UI test case and, for the UI test case, a UI test case summary generated by the TCSG framework of FIGS. 1 and 2.

FIGS. 7A and 7B illustrate the determination of contextual information used in generating UI test case summaries by the TCSG framework of FIGS. 1 and 2.

FIG. 8 illustrates certain operative aspects of TCSG framework of FIGS. 1 and 2.

### DETAILED DESCRIPTION

While the disclosure concludes with claims defining novel features, it is believed that the various features described within this disclosure will be better understood from consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to UIs and UXs associated with interactive computer programs, and more particularly, to generating summaries of UI/UX test cases. End-to-end testing of an application (e.g., web application) exercises the application via the application's UI. The test, to a large extent, mimics the way a user would navigate through the application. Unlike unit testing, which only targets isolated methods or functions of an application, end-to-end testing tests a range of actions that may span multiple methods and/or functions. Owing to the focus on the user's perspective and completeness, end-to-end testing has proven to be useful for various purposes, including, for example, acceptance testing.

Reading and understanding end-to-end test cases, however, is often very difficult, even for application developers. This exacerbates the difficulties of diagnosing failures of end-to-end tests, which tend to be fragile and prone to breakdown in the face of even minor changes to the application's UI. Techniques developed for describing unit tests are not applicable to end-to-end test cases.

In accordance with the inventive arrangements disclosed herein, methods, systems, and computer program products are provided that are capable of generating a UI test case summary of an end-to-end test of a computer application. The UI test case summary provides detailed descriptive information of edges that cause a computer application UI to transition from one state (source state) to another state (target state) during execution of the end-to-end test of the computer application. “Edge,” as used herein, means an action or event that causes the transition of a UI from a source state to a target state. The action or event is typically associated with a clickable, such as a hyperlink, button, or image, or with another element (e.g., voice-activation component) of the UI with which the user initiates an action that causes a UI state transition.

Each edge has one or more attributes. As used herein, “attribute” is a portion of computer code that causes or relates to an edge. For example, an edge that is activated by a clickable (e.g., add button) can correspond to code that, arranged in a hierarchical tree structure, starts with <a> or <button> and comprises nodes corresponding to attributes such as class and/or href. Attributes have values, which comprise abbreviations, words, phrases, and/or other symbols having predetermined meaning. For example, the attribute href may have a value such as “/program actions . . . ” The src, for example, may have the value “,,./images/object_icon.gif”.

The inventive arrangements take as input an end-to-end UI/UX test case that comprises a sequence of UI states and edges. Each edge corresponds to a programmatic action and is associated with a clickable or other element that causes a UI transition from one state to the next. Each UI state is represented by a data structure, specifically a hierarchical tree representation whose nodes are the UI elements (e.g., clickables or widgets) and attributes associated with each UI edge. The inventive arrangements process each attribute of the edges using natural language processing. From the natural language processing, the inventive arrangements infer the actions performed on the application under test as it traverses from one UI state to another during test execution. The inventive arrangements create a label for each edge in the test case flow. The labels, derived from the attributes using natural language processing, describe in more readable form a natural language description of the actions performed during end-to-end testing of the application.

The inventive arrangements combine the labels into a UI test case summary. The UI test case summary generated by the inventive arrangements generates a description of each action or event that causes the UI of the application under test to transition from a source state to a target state. In certain arrangements, the inventive arrangements generate a catalog or digest describing each of multiple end-to-end tests, which are compiled and/or published to thereby enable a user to select and invoke one or more. The compiled and described end-to-end tests can be published electronically and presented to a user on a system during end-to-end testing of the application. The user may select, directly from the published tests, one or more tests for execution. The one or more tests are executed automatically in response to the user selection.

In some embodiments, the inventive arrangements extract elements from comments associated with a UI test case to generate a manual test case. The manual test case can be human-readable. The elements likewise can serve to generate a specification that can be used for translating an original test case to a different testing framework and/or different programming language.

In other arrangements, the inventive arrangements supplement existing UI testing tools. For example, the inventive arrangements can provide a test summarization capability to UI testing tools.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

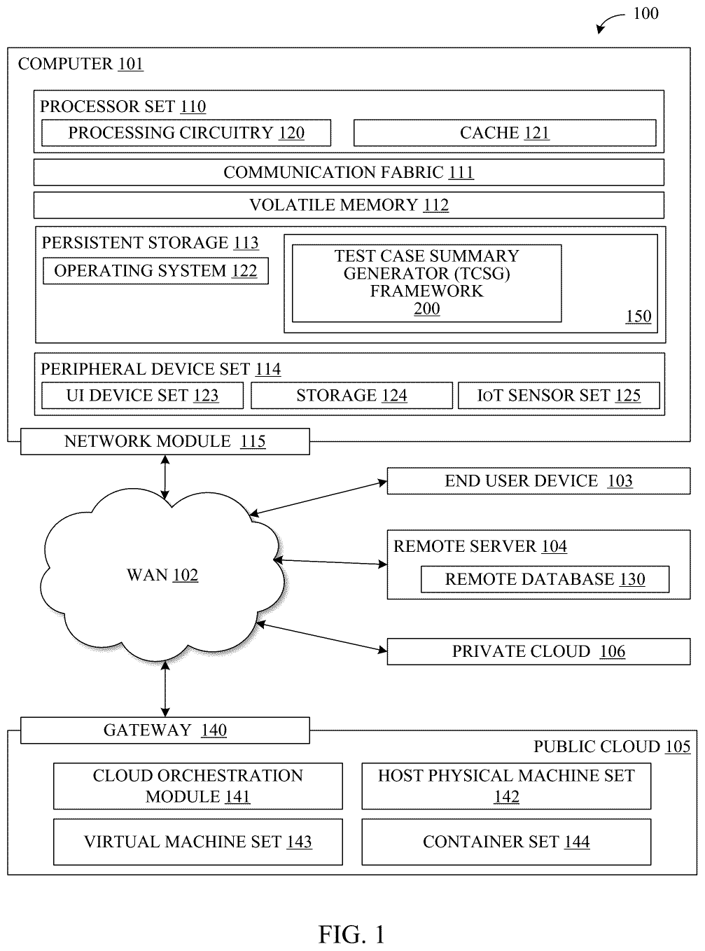

Referring to FIG. 1, computing environment 100 contains an example of an environment for the execution of at least some of the computer code in block 150 involved in performing the inventive methods, such as test case summary generator (TCSG) framework 200 implemented as executable program code or instructions. TCSG framework 200 is capable of generating a UI/UX test case summary of an application under test. The test case summary combines labels derived from attributes of edges that cause transitions from one UI state to another during the execution of an end-to-end test of the application. The labels provide natural language descriptions of the edges, making the end-to-end test results more readily understandable.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ABC/ML TCSG framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

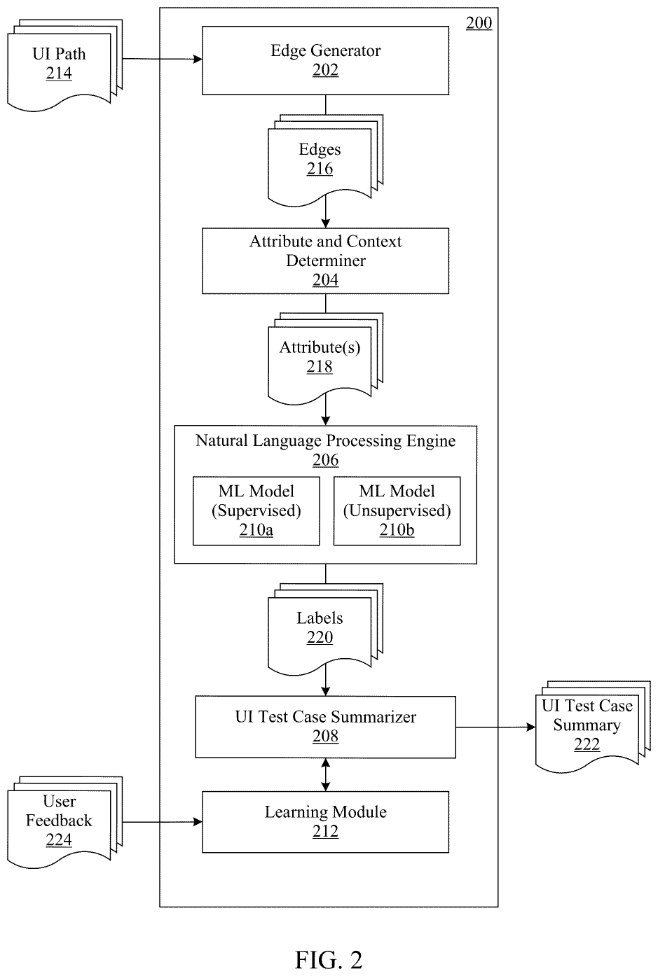

FIG. 2 illustrates an example architecture for the executable TCSG framework 200 of FIG. 1. In the example of FIG. 2, TCSG framework 200 illustratively includes edge identifier 202, attribute and context determiner 204, natural language processing (NLP) engine 206, and UI test case summarizer 208. Optionally, NLP engine 206 is capable of implementing two alternative NLP machine learning (ML) models, ML model 210a and ML model 210b. As described in detail below ML model 210a implements a supervised NLP approach, while ML model 210b implements an unsupervised approach. Each is applicable under different circumstances that TCSG framework 200 is optionally capable of determining. Optionally, TCSG framework 200 also includes learning module 212.

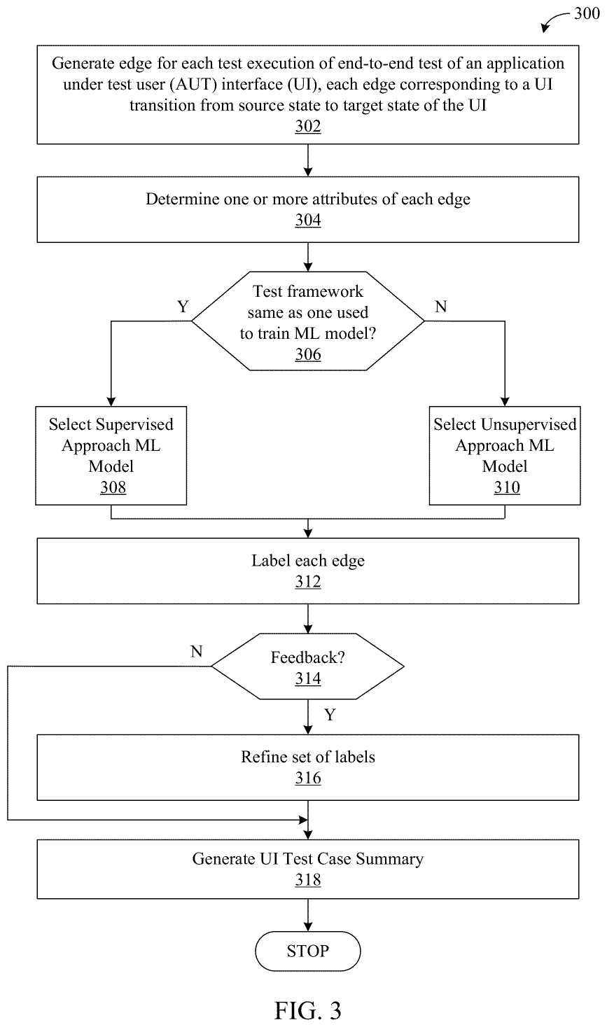

FIG. 3 illustrates an example method 300 of operation of the TCSG framework 200 of FIGS. 1 and 2.

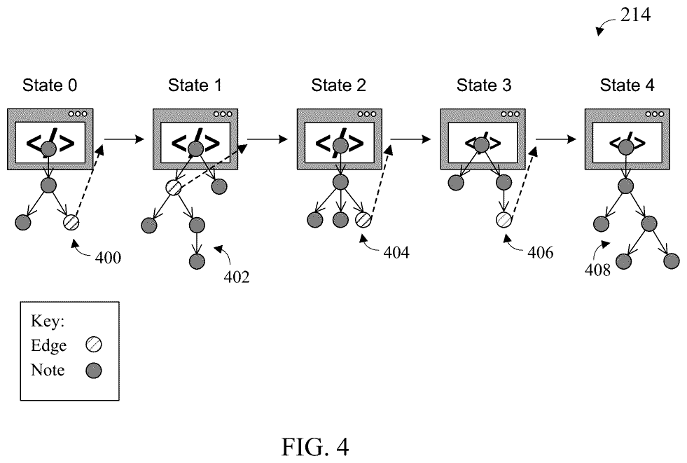

Referring to FIGS. 2 and 3 collectively, in block 302, edge identifier 202 identifies edges for each test execution of an end-to-end test of the user interface of an application under test. The application under test corresponds to UI path 214. UI path 214 comprises a sequence of states of the application UI as illustrated in FIG. 4. Illustratively, only five UI states are shown in FIG. 4, though the number can be any positive integer depending on the specific application. A user views only a sequence of displays, in navigating through the UI, but in FIG. 4 underlying states 0 through 4 along UI path 214 are corresponding data structures 400, 402, 404, 406, and 408. As shown, each of data structures 400 through 408 is a hierarchical tree structure with each node representing an attribute of the application UI in a particular state. For example, for an HTML or XML application, data structures 400 through 408 are each a Document Object Model (DOM) hierarchy. Each of data structures 400 through 408 comprising a hierarchical tree structure may be obtained from a web application browser, which reveals the source code (e.g., html).

Edge identifier 202 identifies edges 216, one for each state of the text execution. Each of edges 216 is an action or event that causes the UI to transition from one state to another. As illustrated in FIG. 4, each edge is identifiable by a node of the hierarchical tree structure of a source state and is identifiable as the executable action or event that causes a transition from the source state to a target state of the UI during testing of the application. An edge can correspond to a clickable or other interactable element, such as a hyperlink, button, image, or other object, or in some cases, for example, a voice-activated or other element. The clickable or other interactable element corresponding to the edge initiates the action or event that effects a transition from a source state to a target state of the UI. Illustratively, for the initial transition in the example of FIG. 4, state 0 is the source state and state 1 is the target state. In the next transition, state 1 is the source state and state 2 is the target state, and so on.

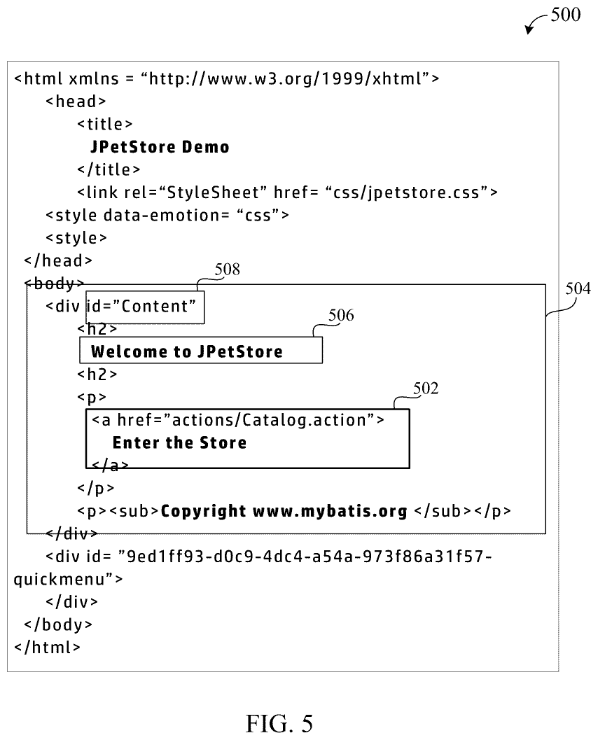

In block 304, attribute and context determiner 204 determines one or more attributes 218 of each edge identified in block 302 by edge identifier 202. Typical attributes of many applications are href, text, title, and others. FIG. 5 illustrates tree structure 500 which represents a UI state of an example web application, “JPetStore,” which enables online pet store shopping. Illustratively an attribute of edge 502 of the UI state corresponding to entering the store is attribute href. The attribute value of href is “actions/Catalog.action.” The attributes are determined from the edges. Other attributes are determined by attribute and context determiner 204 from the context of the edge. In certain embodiments, described in greater detail below, attribute and context determiner 204 begins with the edge (or corresponding clickable) and traverses upward along branches of the tree until reaching another edge (or corresponding clickable) or root. The subtree resulting from the traversal determines a context of the edge. In FIG. 5, context 504 includes text attribute 506, whose value is the text, Welcome to JPetStore and id attribute 508, whose value is “content.”

Given that end-to-end testing of an application consists of actions (e.g., clicks) performed on or with the application UI, it is typically difficult to understand a test case simply by reading a listing of the code corresponding to the various transitions from one UI state to another. This is especially so if the actions that cause the transitions are performed via application program interfaces (APIs) of a testing framework used to create the test. Thus, TCSG framework 200 generates a summary that annotates the actions using labels 220 generated based on attributes 218 of edges 216. Labels 220 provide descriptive information pertaining to each action of edges 216 that causes a testing transition from one UI state to another UI state. To generate labels 220, NLP engine 206 performs NLP of attributes 218.

In block 306, TCSG framework 200 optionally determines the testing framework used to generate the test case. If the framework is one that was used to generate a test that is among the tests comprising the training sample for training ML model 210a using supervised learning, then ML model 210a is automatically selected by NLP engine 206 in block 308. Otherwise, ML model 210b is selected in block 310. “Framework,” as used herein, means a UI front-end (e.g., web UI) used to implement an application. Training the ML model is performed using multiple test cases generated for a set of applications (e.g., web applications).

The supervised approach of ML model 210a is implemented with an attributes list of the most representative attributes of each edge or clickable associated with an edge. The attributes list is compiled by determining the frequency of attributes for each edge of each test case included in the training sample, and for each edge, selecting ones occurring with a frequency greater than a predetermined threshold. When performing NLP for a newly presented test case, ML model 210a extracts the attribute values (e.g., words or phrases) of the attributes identified from the attributes list. The extracted attribute values can be parsed into a bag of words according to their occurrence frequencies. To avoid extractions that may not yield meaningful results, the extracted values are preprocessed. Preprocessing may include tokenizing each value into tokens, lemmatizing the tokens, removing tokens corresponding to stop words, and removing tokens that do not correspond to the language (e.g., non-English) of the application under test. Keywords are extracted from the preprocessed attribute values using a Bidirectional Encoder Representation of Transformers (BERT) model (e.g., KeyBERT). Candidate keywords or phrases are created as n-grams representing word sequences, and BERT-based embedded representations for the candidate keywords and/or phrases are created. A probability is determined for each candidate and the one having the highest probability is selected for generating a label.

The unsupervised approach of ML model 210b implements one or more probabilistic context-free grammars (PCFGs). Natural language processing (NLP) engine 206 selects ML model 210b in response to determining that the application under test was created using framework different than ones used to train ML model 210a and thus may not contain attributes present in the attribute list of ML model 210a. Using the PCFG, ML model 210b leverages parts-of-speech (POS) tag analysis to extract relevant keywords that might represent an action invoked by the clickable or other element associated with the edges identified in UI path 214. The clickable or other element may contain a start symbol such as <a> or <button> along with attributes such as class or href as offspring nodes of the node containing the start symbol. ML model 210b preprocesses attribute values (e.g., tokenizing the values and removing stop or foreign words). A parse tree representation with POS tags is generated by ML model 210b using, for example, a statistical natural language parser such as the Stanford CoreNLP parser. ML model 210b feeds all the parse tree representations into one or more PCFGs, obtaining production rules with associated probabilities using, for example, the Natural Language Toolkit (NLTK) library. ML model 210b can use a lexicon that links syntactic and semantic patterns to replace any incorrectly identified POS tags. From the parse tree, ML model 210b selects (e.g., using VerbNET) the verb and noun with the highest probabilities, thus creating a label comprising a verb-noun pair that describes the action of the edge.

In block 312, UI test case summarizer 208 uses labels 220 generated by NLP engine 206 based on attributes 218 to label each of edges 216. Optionally, UI test case summarizer 208 distinguishes edges that represent programmatic actions related to application-specific program logic and edges unrelated to application-specific program logic. A navigational action is one that transitions a user from one UI state (e.g., web page) to another. A programmatic action, related to application-specific program logic (e.g., business logic) of the application, results in either server-side queries (e.g., search for items in a shopping or other application) or causes one or more updates in the persistent state of the application (e.g., an action adds items to a cart or checks out the cart). Optionally, UI test case summarizer 208 identifies edges corresponding to application-specific program logic transitions and edges unrelated to application-specific program logic transitions and generates labels only for the edges corresponding to application-specific program logic transitions.

In block 314, TCSG framework 200 optionally determines whether the user wishes to enhance or modify test case summary 222. If so, optional learning module 212 refines one or more of labels 220 in response to user feedback 224.

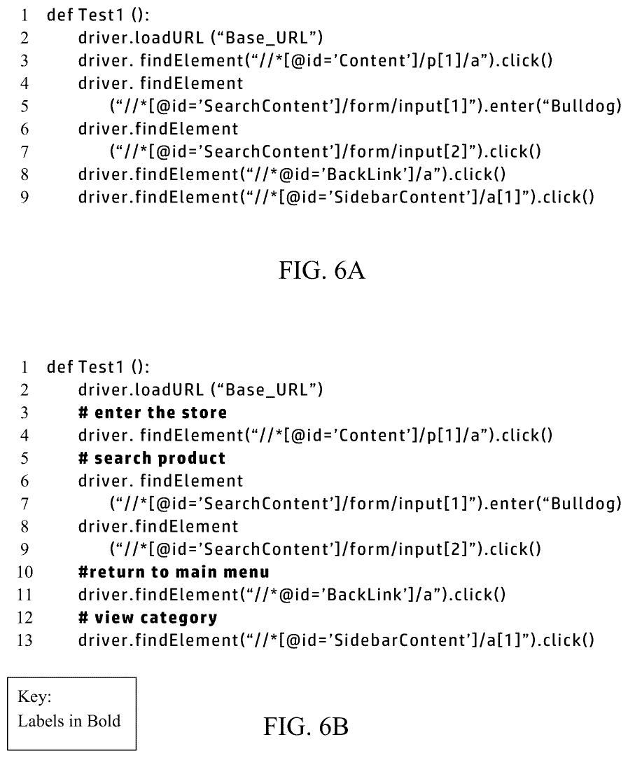

In block 316, UI test case summarizer 208 outputs UI test case summary 222. UI test case summary 222 combines labels corresponding to edges 216 to make the test case more readable and more readily understood. FIGS. 6A and 6B illustrate the effect of labeling edges 216 with labels 220. FIGS. 6A and 6B illustrate an example of test case summary 222 for an end-to-end test of the above-described example application JPetStore. In FIG. 6A, code 600 is an unannotated listing of the computer actions of an end-to-end UI test case of the application. In FIG. 6B, the example of test case summary 222 includes labels that describe each of the edges of the end-to-end UI test case. The labels are shown in bold at lines 3, 5, 10, and 12 of FIG. 6B.

The descriptiveness of labels 220 may be enhanced by contextual information derived from the UI source state and/or UI target state corresponding to an edge. As used herein, “contextual information” means attributes and their values derived from the context of an edge, where the context is derived from the source state and/or the target state of the edge. Attribute and context determiner 204 thus optionally may determine contextual information related to an edge from attributes of the UI source state and/or the UI target state corresponding a transition caused by the edge.

To extract attribute values from the source state, attribute and context determiner 204 locates a clickable associated with the edge from the hierarchical tree structure (e.g., DOM). Attribute and context determiner 204 traverses through the hierarchical tree structure, identifying a parent element level by level until encountering another clickable. The values of attributes identified through the traversal are parsed into a bag of words by attribute and context determiner 204. The values are preprocessed by tokenization, lemmatization, and removal of stop and/or foreign words. Attribute and context determiner 204 extracts keywords from the preprocessed attribute values (e.g., words or phrases) using either the BERT-based or PCFG-based extraction techniques described above. For example, referring again to FIG. 5, context 504 of edge 502 corresponds to the source state, state 0. Context 504 of edge 502 is determined from the hierarchical tree structure of the source state. The source state includes text attribute 506 “whose value is the text, Welcome to JPetStore, and id attribute 508, whose value is “content.”

The edge causes the transition from the source state to the target state of the UI, and hence, additional contextual information also may be derived from the target state corresponding to the edge by attribute and context determiner 204's performing essentially the same process with respect to the target state of the edge. Thus, in the target state context, attribute and context determiner extracts attribute values and parses the attribute values into a bag of words. The extracted attribute values are preprocessed through tokenization, lemmatization, and removal of stop and/or foreign words. From the preprocessed attribute values, attribute and context determiner 204 extracts keywords as described already and generates from the key words labels 220.

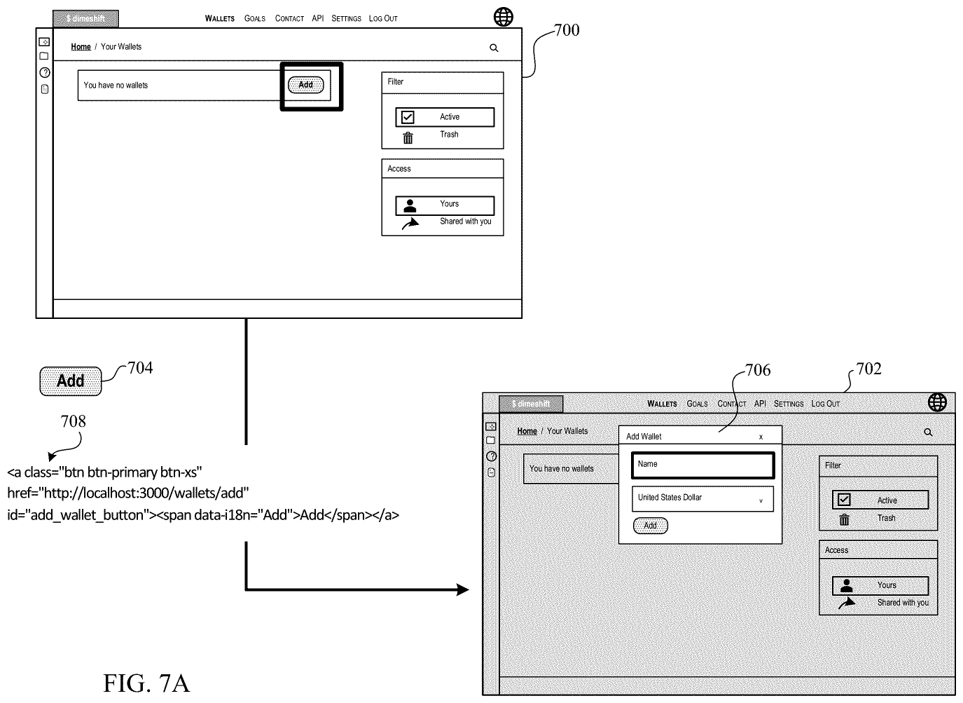

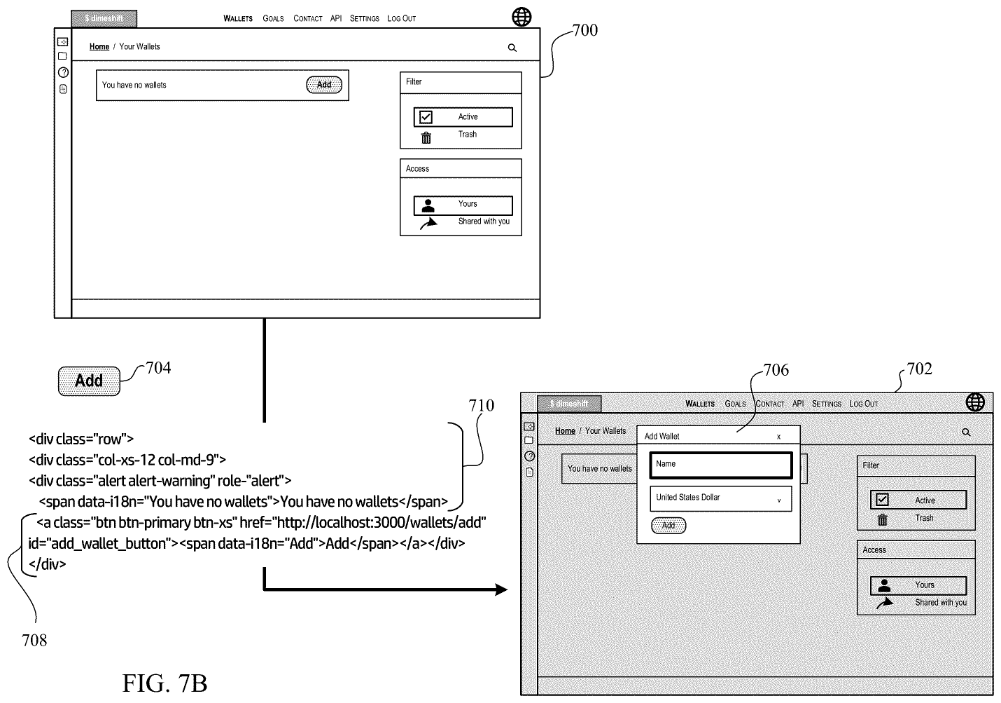

FIGS. 7A and 7B illustrate determination of additional contextual information from the target state of an edge. In FIG. 7A, display 700 corresponds to the source state, which transitions to display 702, corresponding to the target state, in response to the edge. The edge is an event, namely a user activation of the clickable, add button 704. Code 708 corresponds to the edge, whose attributes are href having values “http://localhost:3000/wallets/add.” class having values “btn btn-primary btn-xs,” and id having values “add wallet button . . . ” The transition to the target state corresponds to action 706, add wallet. Additional contextual is derived by attribute and context determiner 204 from code 710 arranged in the transition state's hierarchical tree structure above code 708. Traversing the hierarchical tree structure, attribute and context determiner 204 obtains attributes class having value “row,” class having value “alert alert-warning.” role having value “alert,” and span data-i18 having value “you have no wallets.” Attribute and context determiner 204 extracts keywords from the additional contextual information, as described, and generates labels 220 from the extracted keywords. Attribute and context determiner uses labels 220 for generating UI test case summary 222, as also described above.

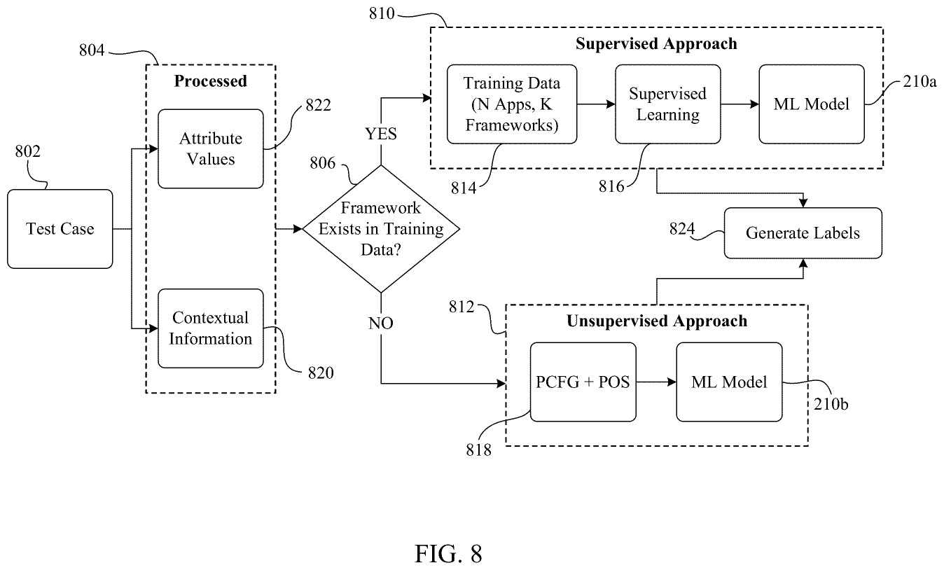

FIG. 8 illustrates certain operative features of TCSG framework 200. Illustratively, end-to-end UI text case 802 undergoes processing 804 by edge identifier 202, attribute and context determiner 204, NLP engine 206, as already described. Processing 804 generates attribute values 822 and contextual information 820. Determination 806 relates to the UI framework used by the application under test. The determination is whether the UI framework is among those used by the applications that were part of the set for training ML model 210a. If so, then TCSG framework 200 implements supervised approach 810. Supervised approach 810 uses ML model 210a, which is trained using supervised learning 816 on training data 814. Training data 814 can include N application tests created with K different frameworks. Otherwise, if the UI framework used by the application under test is not among those used by the applications as part of the set for training ML model 210a, then TCSG framework 200 implements unsupervised approach 812. Unsupervised approach 812 uses ML model 210b, which is implemented using one or more PCFGs plus POS tagging 818. Using either approach, TCSG framework 200 performs label generation 824. The generated labels are combined to output the UI test case summary of end-to-end UI test case 802.

The terminology used herein is for the purpose of describing particular embodiments only and is not intended to be limiting. Notwithstanding, several definitions that apply throughout this document will now be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a processor, an edge for each test execution of an end-to-end test of an application under test (AUT) user interface (UI), wherein each edge corresponds to a transition of the UI from a source state to a target state of the UI;
determining, by the processor, one or more attributes of each edge;
generating, by a natural language processing (NLP) engine, a label for each edge, wherein each label is derived from the one or more attributes of each edge; and
outputting a test case summary of the end-to-end test, wherein in the test case summary combines labels corresponding to each edge.

2. The method of claim 1, wherein the determining the one or more attributes of each edge includes determining contextual information based on attributes of the source state corresponding to each edge.

3. The method of claim 1, wherein the determining the one or more attributes of each edge includes determining contextual information based on attributes of the target state corresponding to each edge.

4. The method of claim 1, wherein the NLP engine is configured to selectively implement one of multiple NLP models, and wherein the method further comprises:
selecting an NLP model trained using supervised learning to generate a label for each edge, wherein the selecting is in response to determining that the AUT is created using a framework used to create other AUTs comprising a training set for training the NLP engine.

5. The method of claim 1, wherein the NLP engine is configured to selectively implement one of multiple NLP models, and wherein the method further comprises:
selecting an NLP model trained using unsupervised learning to generate a label for each edge, wherein the selecting is in response to determining that the AUT is created using a framework different from each used to create other AUTs comprising a training set for training the NLP engine, and wherein the NLP model trained using unsupervised learning generates the one or more labels for each edge using a probabilistic context-free grammar.

6. The method of claim 1, further comprising:
identifying edges corresponding to application-specific program logic transitions and edges unrelated to application-specific program logic transitions; and
generating labels only for edges corresponding to application-specific program logic transitions.

7. The method of claim 1, further comprising:
implementing a learning module that refines the labels and/or generates additional labels for one or more edges based on user feedback.

8. A system, comprising:
one or more processors configured to initiate operations including:
identifying an edge for each test execution of an end-to-end test of an application under test (AUT) user interface (UI), wherein each edge corresponds to a transition of the UI from a source state to a target state of the UI;
determining one or more attributes of each edge;
generating, by a natural language processing (NLP) engine, a label for each edge, wherein each label is derived from the one or more attributes of each edge; and
outputting a test case summary of the end-to-end test, wherein in the test case summary combines labels corresponding to each edge.

9. The system of claim 8, wherein the determining one or more attributes of each edge includes determining contextual information based on attributes of the source state corresponding to each edge.

10. The system of claim 8, wherein the determining one or more attributes of each edge includes determining contextual information based on attributes of the target state corresponding to each edge.

11. The system of claim 8, wherein the NLP engine selectively implements one of multiple NLP models, and wherein the one or more processors are configured to initiate operations further including:
selecting an NLP model trained using supervised learning to generate a label for each edge, wherein the selecting is in response to determining that the AUT is created using a framework used to create other AUTs comprising a training set for training the NLP engine.

12. The system of claim 8, wherein the NLP engine selectively implements one of multiple NLP models, and wherein the one or more processors are configured to initiate operations further including:
selecting an NLP model trained using unsupervised learning to generate a label for each edge, wherein the selecting is in response to determining that the AUT is created using a framework different from each used to create other AUTs comprising a training set for training the NLP engine, and wherein the NLP model trained using unsupervised learning generates the one or more labels for each edge using a probabilistic context-free grammar.

13. The system of claim 8, wherein the one or more processors are configured to initiate operations further including:
identifying edges corresponding to application-specific program logic transitions and edges unrelated to application-specific program logic transitions; and
generating labels only for edges corresponding to application-specific program logic transitions.

14. A computer program product, the computer program product comprising:
one or more computer-readable storage media and program instructions collectively stored on the one or more computer-readable storage media, the program instructions executable by a processor to cause the processor to initiate operations including:
identifying an edge for each test execution of an end-to-end test of an application under test (AUT) user interface (UI), wherein each edge corresponds to a transition of the UI from a source state to a target state of the UI;
determining one or more attributes of each edge;
generating, by a natural language processing (NLP) engine, a label for each edge, wherein each label is derived from the one or more attributes of each edge; and
outputting a test case summary of the end-to-end test, wherein in the test case summary combines labels corresponding to each edge.

15. The computer program product of claim 14, wherein the determining one or more attributes of each edge includes determining contextual information based on attributes of the source state corresponding to each edge.

16. The computer program product of claim 14, wherein the determining one or more attributes of each edge includes determining contextual information based on attributes of the target state corresponding to each edge.

17. The computer program product of claim 14, wherein the NLP engine selectively implements one of multiple NLP models, and wherein the wherein the program instructions are executable by the processor to cause the processor to initiate operations further including:
selecting an NLP model trained using supervised learning to generate a label for each edge, wherein the selecting is in response to determining that the AUT is created using a framework used to create other AUTs comprising a training set for training the NLP engine.

18. The computer program product of claim 14, wherein the NLP engine selectively implements one of multiple NLP models, and wherein the program instructions are executable by the processor to cause the processor to initiate operations further including:
selecting an NLP model trained using unsupervised learning to generate a label for each edge, wherein the selecting is in response to determining that the AUT is created using a framework different from each used to create other AUTs comprising a training set for training the NLP engine, and wherein the NLP model trained using unsupervised learning generates the one or more labels for each edge using a probabilistic context-free grammar.

19. The computer program product of claim 14, wherein the program instructions are executable by the processor to cause the processor to initiate operations further including:
identifying edges corresponding to application-specific program logic transitions and edges unrelated to application-specific program logic transitions; and
generating labels only for edges corresponding to application-specific program logic transitions.

20. The computer program product of claim 14, wherein the program instructions are executable by the processor to cause the processor to initiate operations further including:
refining the labels and/or generating additional labels for one or more edges based on user feedback.
